(19) United States
(12) Patent Application Publication
(10) Pub. No.: US 2026/0075114 A1
(43) Pub. Date: Mar. 12, 2026

(54) SYSTEMS AND METHODS FOR RUNNING CLIENT-SIDE LOGIC ON A SERVER

(71) Applicant: ServiceNow, Inc., Santa Clara, CA (US)

(72) Inventors: Gaurav Goyal, San Jose, CA (US); Mohammed Furqan, Hyderabad (IN)

(21) Appl. No.: 18/828,550

(22) Filed: Sep. 9, 2024

(51) Int. Cl. H04L 67/2895; G06F 40/174; H04L 67/562

(52) U.S. Cl. CPC H04L 67/2895; G06F 40/174; H04L 67/562

(57) ABSTRACT

A method includes receiving, from a client device, a request to fill out a form, retrieving a script associated with the form, generating on a server, via a javascript proxy object, data based on the script, and transmitting the data to the client device.

### TECHNICAL FIELD

The present disclosure relates generally to running logic for fillable forms, and more specifically to running logic for fillable forms outside of a browser.

### BACKGROUND

This section is intended to introduce the reader to various aspects of art that may be related to various aspects of the present disclosure, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

Organizations, regardless of size, rely upon access to information technology (IT) and data and services for their continued operation and success. A respective organization's IT infrastructure may have associated hardware resources (e.g. computing devices, as well as IT infrastructure, such as routers, load balancers, firewalls, switches, etc.) and software resources (e.g. productivity software, database applications, large language models (LLMs), generative artificial intelligence (AI) applications, custom applications, and so forth). Over time, more and more organizations have turned to cloud computing approaches to supplement or enhance their IT infrastructure solutions.

Cloud computing relates to the sharing of computing resources that are generally accessed via the Internet. In particular, a cloud computing infrastructure allows users, such as individuals and/or enterprises, to access a shared pool of computing resources, such as servers, storage devices, networks, applications, and/or other computing-based services. By doing so, users are able to access computing resources on demand that are located at remote locations. These resources may be used to perform a variety of computing functions (e.g., storing and/or processing large quantities of computing data). For enterprise and other organization users, cloud computing provides flexibility in accessing cloud computing resources without accruing large up-front costs, such as purchasing expensive network equipment or investing large amounts of time in establishing a private network infrastructure. Instead, by utilizing cloud computing resources, users are able to redirect their resources to focus on their enterprise's core functions.

In cloud-based architectures, a web browser is often used on the client side to access and complete fillable forms. Forms that are embedded in web pages accessible by a browser utilize logic (e.g., scripts and/or policies defining allowed combinations of field values in the form) that are stored in the document object model (DOM) of the web page. Accordingly, the browser retrieves the logic from the DOM and executes and/or applies the logic to update the form as fields of the form are populated based on received inputs. As virtual (e.g., non-human) agents become more prevalent and more proficient at performing tasks, it may be more efficient to fill out a form (e.g., to submit an order for an item) via a virtual agent than by manually filling out a form via a browser. However, virtual agents that run outside of a browser do not have access to a web page's DOM and thus do not have a way to run logic that is typically run on the client side via a browser. This can lead to forms being submitted with incompatible combinations of field values, causing problems when submitted forms are processed. Accordingly, new techniques for enabling resources external to a browser to run logic that is typically run by a browser on the client side are needed.

### SUMMARY

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

In an embodiment, a method includes receiving, from a client device, a request to fill out a form, retrieving a script associated with the form, generating, via a javascript proxy object, data based on the script, and transmitting the data to the client device.

In another embodiment, a system includes processing circuitry and a memory, accessible by the processing circuitry, storing instructions that, when executed by the processing circuitry, cause the processing circuitry to execute a client configured to receive, from a client device, a request to fill out a form, retrieve a script associated with the form, generate, via a javascript proxy object, data based on the script, and transmit the data to the client device.

In a further embodiment, a non-transitory, computer readable medium stores instructions that, when executed by processing circuitry, cause the processing circuitry to receive, from a client device, a request to fill out a form, retrieve a script associated with the form, generate, via a javascript proxy object, data based on the script, and transmit the data to the client device.

Various refinements of the features noted above may exist in relation to various aspects of the present disclosure. Further features may also be incorporated in these various aspects as well. These refinements and additional features may exist individually or in any combination. For instance, various features discussed below in relation to one or more of the illustrated embodiments may be incorporated into any of the above-described aspects of the present disclosure alone or in any combination. The brief summary presented above is intended only to familiarize the reader with certain aspects and contexts of embodiments of the present disclosure without limitation to the claimed subject matter.

### BRIEF DESCRIPTION OF THE DRAWINGS

Various aspects of this disclosure may be better understood upon reading the following detailed description and upon reference to the drawings in which:

FIG. 1 is a block diagram of an embodiment of a multi-instance cloud architecture in which embodiments of the present disclosure may operate;

FIG. 2 is a schematic of an embodiment of a multi-instance cloud architecture in which embodiments of the present disclosure may operate;

FIG. 3 is a block diagram of a computing device utilized in a computing system that may be present in FIG. 1 or 2, in accordance with aspects of the present disclosure;

FIG. 4 is a block diagram illustrating a virtual server that supports and enables a client instance, in accordance with aspects of the present disclosure;

FIG. 5 is a screenshot of a web page, accessible via a browser, that includes a form for ordering a mobile phone, in accordance with aspects of the present disclosure;

FIG. 6 is a screenshot of a script editing window for editing a script associated with the form of FIG. 5, in accordance with aspects of the present disclosure;

FIG. 7 is a screenshot of a home screen, accessible via a client device, from which a chat conversation can be launched and conducted in a chat window to order a catalog item, in this case the mobile phone of FIG. 5, via a virtual agent, in accordance with aspects of the present disclosure;

FIG. 8 is the entirety of the chat conversation initiated in FIG. 7, in accordance with aspects of the present disclosure;

FIG. 9 is a flow chart illustrating the operations of the backend system as a form is filled out using resources external to a web browser, such as the chat session with the virtual agent shown in FIGS. 7 and 8, in accordance with aspects of the present disclosure;

FIG. 10 is a flow chart of a process for running client-side logic on a server, in accordance with aspects of the present disclosure;

FIG. 11A is a schematic of client scripts for the mobile phone catalog item of FIG. 5, in accordance with aspects of the present disclosure;

FIG. 11B is a schematic of an on-load execution call stack that represents actions taken when the mobile phone catalog item form of FIG. 5 is loaded, in accordance with aspects of the present disclosure;

FIG. 11C is a schematic of an on-change execution call stack that represents actions taken when a value of a model field of the mobile phone catalog item form of FIG. 5 is changed, in accordance with aspects of the present disclosure;

FIG. 11D is a schematic of an on-submit execution call stack that represents actions taken when values for fields in the mobile phone catalog item form of FIG. 5 are submitted, in accordance with aspects of the present disclosure; and

FIG. 12 is a flow chart of a process for managing form completion when a change is made to the value for fields of the form, in accordance with aspects of the present disclosure.

### DETAILED DESCRIPTION

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers'specific goals, such as compliance with system-related and enterprise-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

Forms that are embedded in web pages accessible by a browser utilize logic (e.g., scripts and/or policies defining allowed combinations of field values in the form) that are stored in the document object model (DOM) of the web page. Accordingly, the browser retrieves the logic from the DOM and executes and/or applies the logic to update the form as fields of the form are populated based on received inputs. As virtual (e.g., non-human) agents become more prevalent and more proficient at performing tasks, it may be more efficient to fill out a form (e.g., to submit an order for an item) via a virtual agent than by manually filling out a form via a browser. However, virtual agents that run outside of a browser do not have access to a web page's DOM and do not have a way to run logic that is typically run on the client side via a browser.

Various embodiments disclosed herein are directed to executing on the server side scripts that are typically executed on the client side (e.g., via a browser). For example, parameters of items within a catalog may be defined by a form. Some catalog items may only be available in specific combinations of parameters. For example, a more premium trim level of a mobile phone may be available in different colors and/or different memory capacities than a more basic trim level of the phone. Logic dictating which combinations of parameters are available is defined by scripts, which are typically stored in a document object model (DOM) of the form's webpage. The browser typically extracts the scripts from the DOM and runs the scripts on the client device to apply the logic. However, attempts to fill in forms using resources that are external to a browser (e.g., via a virtual agent) may result in forms being submitted with combinations of parameters that do not exist because the resources that are external to the browser do not have access to the DOM, and thus do not have access to the scripts that define the logic. In the presently disclosed embodiments, the scripts are retrieved from a scripts database and executed by a javascript proxy object on the server side. Execution of the scripts results in data used to determine which combinations of parameters are possible, enabling options to be provided to a client device in a conversational format. Further, if inputs are received that make a change to a previously defined parameter, the scripts may be re-run to determine the available combinations of parameters based on the change.

Use of the disclosed techniques enables logic (e.g., client-side scripts) that is typically run on the client side to be run on the server side. Accordingly, using the disclosed techniques, resources that are external to a browser, such virtual agents, can be used to fill in forms and inputs/submissions can be checked by running logic on the server side. As a result, form submissions with inputs that violate logic, which can greatly reduce process efficiency and be resource intensive to correct, are greatly reduced.

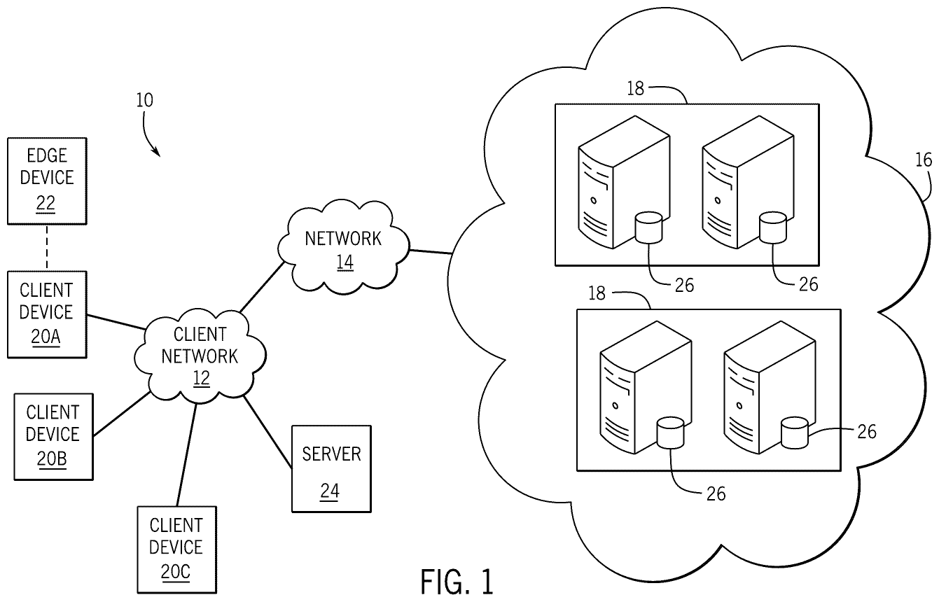

With the preceding in mind, the following figures relate to various types of generalized system architectures or configurations that may be employed to provide services to an organization for which the present approaches may be employed. Correspondingly, these system and platform examples may also relate to systems and platforms on which the techniques discussed herein may be implemented or otherwise utilized. Turning now to FIG. 1, a schematic diagram of an embodiment of a cloud computing system 10 where embodiments of the present disclosure may operate, is illustrated. The cloud computing system 10 may include a client network 12, a network 14 (e.g., the Internet), and a cloud-based platform 16. In one embodiment, the client network 12 may be a local private network, such as local area network (LAN) having a variety of network devices that include, but are not limited to, switches, servers, and routers. In another embodiment, the client network 12 represents an enterprise network that could include one or more LANs, virtual networks, data centers 18, and/or other remote networks. As shown in FIG. 1, the client network 12 is able to connect to one or more client devices 20A, 20B, and 20C so that the client devices are able to communicate with each other and/or with the network hosting the platform 16. The client devices 20A, 20B, 20C may be computing systems and/or other types of computing devices that access cloud computing services, for example, via a web browser application or via an edge device 22 that may act as a gateway between the client devices 20A, 20B, 20C and the platform 16. FIG. 1 also illustrates that the client network 12 includes an administration or managerial application, device, agent, or server, such as a server 24 that facilitates communication of data between the network hosting the platform 16, other external applications, data sources, and services, and the client network 12. Although not specifically illustrated in FIG. 1, the client network 12 may also include a connecting network device (e.g., a gateway or router) or a combination of devices that implement a customer firewall or intrusion protection system.

For the illustrated embodiment, FIG. 1 illustrates that client network 12 is coupled to the network 14, which may include one or more computing networks, such as other LANs, wide area networks (WAN), the Internet, and/or other remote networks, to transfer data between the client devices 20A, 20B, 20C and the network hosting the platform 16. Each of the computing networks within network 14 may contain wired and/or wireless programmable devices that operate in the electrical and/or optical domain. For example, network 14 may include wireless networks, such as cellular networks (e.g., Global System for Mobile Communications (GSM) based cellular network), IEEE 802.11 networks, and/or other suitable radio-based networks. The network 14 may also employ any number of network communication protocols, such as Transmission Control Protocol (TCP) and Internet Protocol (IP). Although not explicitly shown in FIG. 1, network 14 may include a variety of network devices, such as servers, routers, network switches, and/or other network hardware devices configured to transport data over the network 14.

In FIG. 1, the network hosting the platform 16 may be a remote network (e.g., a cloud network) that is able to communicate with the client devices 20A, 20B, 20C via the client network 12 and network 14. The network hosting the platform 16 provides additional computing resources to the client devices 20A, 20B, 20C and/or the client network 12. For example, by utilizing the network hosting the platform 16, users of the client devices 20A, 20B, 20C are able to build and execute applications and/or workflows for various enterprise, IT, and/or other organization-related functions. In one embodiment, the network hosting the platform 16 is implemented on the one or more data centers 18, where each data center could correspond to a different geographic location. Each of the data centers 18 includes a plurality of virtual servers 26 (also referred to herein as application nodes, application servers, virtual server instances, application instances, or application server instances), where each virtual server 26 can be implemented on a physical computing system, such as a single electronic computing device (e.g., a single physical hardware server) or across multiple-computing devices (e.g., multiple physical hardware servers). Examples of virtual servers 26 include, but are not limited to a web server (e.g., a unitary Apache installation), an application server (e.g., unitary JAVA Virtual Machine), and/or a database server (e.g., a unitary relational database management system (RDBMS) catalog).

To utilize computing resources within the platform 16, network operators may choose to configure the data centers 18 using a variety of computing infrastructures. In one embodiment, one or more of the data centers 18 are configured using a multi-tenant cloud architecture, such that one of the server instances 26 handles requests from and serves multiple customers. Data centers 18 with multi-tenant cloud architecture commingle and store data from multiple customers, where multiple customer instances are assigned to one of the virtual servers 26. In a multi-tenant cloud architecture, the particular virtual server 26 distinguishes between and segregates data and other information of the various customers. For example, a multi-tenant cloud architecture could assign a particular identifier for each customer in order to identify and segregate the data from each customer. Generally, implementing a multi-tenant cloud architecture may suffer from various drawbacks, such as a failure of a particular one of the server instances 26 causing outages for all customers allocated to the particular server instance.

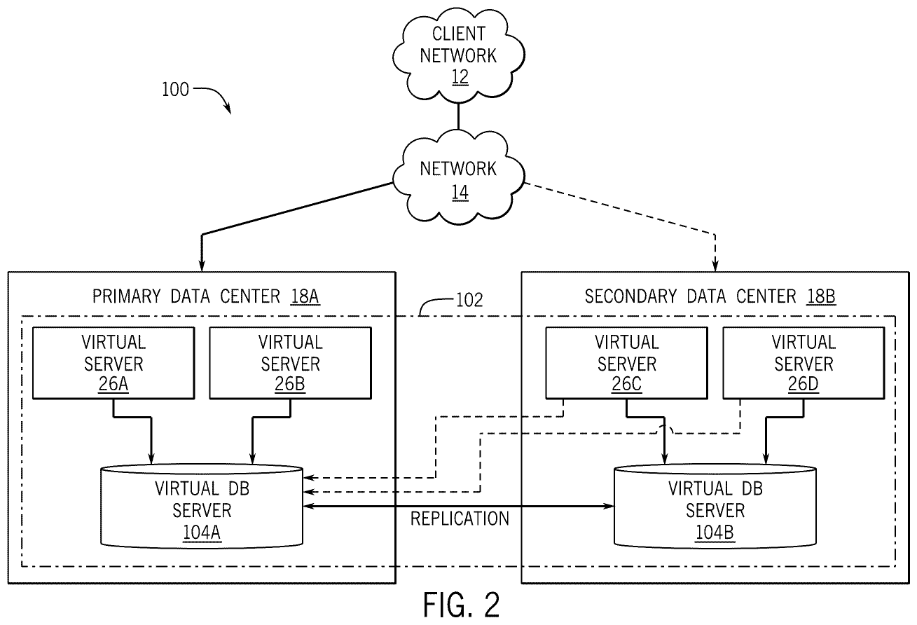

In another embodiment, one or more of the data centers 18 are configured using a multi-instance cloud architecture to provide every customer its own unique customer instance or instances. For example, a multi-instance cloud architecture could provide each customer instance with its own dedicated application server(s) and dedicated database server(s). In other examples, the multi-instance cloud architecture could deploy a single physical or virtual server 26 and/or other combinations of physical and/or virtual servers 26, such as one or more dedicated web servers, one or more dedicated application servers, and one or more database servers, for each customer instance. In a multi-instance cloud architecture, multiple customer instances could be installed on one or more respective hardware servers, where each customer instance is allocated certain portions of the physical server resources, such as computing memory, storage, and processing power. By doing so, each customer instance has its own unique software stack that provides the benefit of data isolation, relatively less downtime for customers to access the platform 16, and customer-driven upgrade schedules. An example of implementing a customer instance within a multi-instance cloud architecture will be discussed in more detail below with reference to FIG. 2.

FIG. 2 is a schematic diagram of an embodiment of a multi-instance cloud architecture 100 where embodiments of the present disclosure may operate. FIG. 2 illustrates that the multi-instance cloud architecture 100 includes the client network 12 and the network 14 that connect to two (e.g., paired) data centers 18A and 18B that may be geographically separated from one another and provide data replication and/or failover capabilities. Using FIG. 2 as an example, network environment and service provider cloud infrastructure client instance 102 (also referred to herein as a client instance 102) is associated with (e.g., supported and enabled by) dedicated virtual servers (e.g., virtual servers 26A, 26B, 26C, and 26D) and dedicated database servers (e.g., virtual database servers 104A and 104B). Stated another way, the virtual servers 26A-26D and virtual database servers 104A and 104B are not shared with other client instances and are specific to the respective client instance 102. In the depicted example, to facilitate availability of the client instance 102, the virtual servers 26A-26D and virtual database servers 104A and 104B are allocated to two different data centers 18A and 18B so that one of the data centers 18 acts as a backup data center. Other embodiments of the multi-instance cloud architecture 100 could include other types of dedicated virtual servers, such as a web server. For example, the client instance 102 could be associated with (e.g., supported and enabled by) the dedicated virtual servers 26A-26D, dedicated virtual database servers 104A and 104B, and additional dedicated virtual web servers (not shown in FIG. 2).

Although FIGS. 1 and 2 illustrate specific embodiments of a cloud computing system 10 and a multi-instance cloud architecture 100, respectively, this disclosure is not limited to the specific embodiments illustrated in FIGS. 1 and 2. For instance, although FIG. 1 illustrates that the platform 16 is implemented using data centers, other embodiments of the platform 16 are not limited to data centers and can utilize other types of remote network infrastructures. Moreover, other embodiments of the present disclosure may combine one or more different virtual servers into a single virtual server or, conversely, perform operations attributed to a single virtual server using multiple virtual servers. For instance, using FIG. 2 as an example, the virtual servers 26A, 26B, 26C, 26D and virtual database servers 104A, 104B may be combined into a single virtual server. Moreover, the present approaches may be implemented in other architectures or configurations, including, but not limited to, multi-tenant architectures, generalized client/server implementations, and/or even on a single physical processor-based device configured to perform some or all of the operations discussed herein. Similarly, though virtual servers or machines may be referenced to facilitate discussion of an implementation, physical servers may instead be employed as appropriate. The use and discussion of FIGS. 1 and 2 are only examples to facilitate ease of description and explanation and are not intended to limit the disclosure to the specific examples illustrated therein.

As may be appreciated, the respective architectures and frameworks discussed with respect to FIGS. 1 and 2 incorporate computing systems of various types (e.g., servers, workstations, client devices, laptops, tablet computers, cellular telephones, edge devices, and so forth) throughout. For the sake of completeness, a brief, high level overview of components typically found in such systems is provided. As may be appreciated, the present overview is intended to merely provide a high-level, generalized view of components typical in such computing systems and should not be viewed as limiting in terms of components discussed or omitted from discussion.

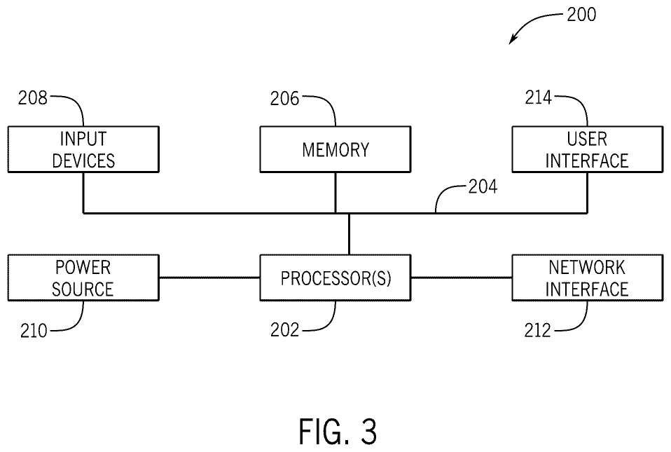

By way of background, it may be appreciated that the present approach may be implemented using one or more processor-based systems such as shown in FIG. 3. Likewise, applications and/or databases utilized in the present approach may be stored, employed, and/or maintained on such processor-based systems. As may be appreciated, such systems as shown in FIG. 3 may be present in a distributed computing environment, a networked environment, or other multi-computer platform or architecture. Likewise, systems such as that shown in FIG. 3, may be used in supporting or communicating with one or more virtual environments or computational instances on which the present approach may be implemented.

With this in mind, an example computing system 200 may include some or all of the computer components depicted in FIG. 3. FIG. 3 generally illustrates a block diagram of example components of a computing system 200 and their potential interconnections or communication paths, such as along one or more busses. As illustrated, the computing system 200 may include various hardware components such as, but not limited to, one or more processors 202 (e.g., processing circuitry), one or more busses 204, memory 206, input devices 208, a power source 210, a network interface 212, a user interface 214, and/or other computer components useful in performing the functions described herein.

The one or more processors 202 may include one or more microprocessors capable of performing instructions stored in the memory 206. Additionally or alternatively, the one or more processors 202 may include application-specific integrated circuits (ASICs), field-programmable gate arrays (FPGAs), and/or other devices designed to perform some or all of the functions discussed herein without calling instructions from the memory 206.

With respect to other components, the one or more busses 204 include suitable electrical channels to provide data and/or power between the various components of the computing system 200. The memory 206 may include any tangible, non-transitory, and computer-readable storage media. Although shown as a single block in FIG. 1, the memory 206 can be implemented using multiple physical units of the same or different types in one or more physical locations. The input devices 208 correspond to structures to input data and/or commands to the one or more processors 202. For example, the input devices 208 may include a mouse, touchpad, touchscreen, keyboard and the like. The power source 210 can be any suitable source for power of the various components of the computing device 200, such as line power and/or a battery source. The network interface 212 includes one or more transceivers capable of communicating with other devices over one or more networks (e.g., a communication channel). The network interface 212 may provide a wired network interface or a wireless network interface. A user interface 214 may include a display that is configured to display text or images transferred to it from the one or more processors 202. In addition and/or alternative to the display, the user interface 214 may include other devices for interfacing with a user, such as lights (e.g., LEDs), speakers, and the like.

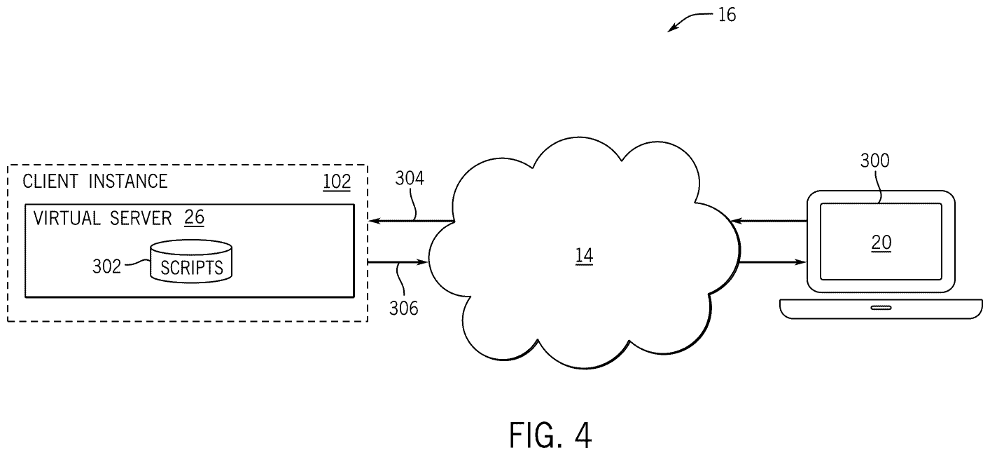

With the preceding in mind, FIG. 4 is a block diagram illustrating an embodiment in which a virtual server 26 supports and enables the client instance 102, according to one or more disclosed embodiments. More specifically, FIG. 4 illustrates an example of a portion of a service provider cloud infrastructure, including the cloud-based platform 16 discussed above. The cloud-based platform 16 is connected to a client device 20 via the network 14 to provide a user interface to network applications executing within the client instance 102 (e.g., via a web browser 300 or a native application running on the client device 20). Client instance 102 is supported by virtual servers 26 similar to those explained with respect to FIG. 2, and is illustrated here to show support for the disclosed functionality described herein within the client instance 102. Cloud provider infrastructures are generally configured to support a plurality of end-user devices, such as client device(s) 20, concurrently, wherein each end-user device is in communication with the single client instance 102. Also, cloud provider infrastructures may be configured to support any number of client instances, such as client instance 102, concurrently, with each of the instances in communication with one or more end-user devices. As mentioned above, an end-user may also interface with the client instance 102 using an application and/or a web browser 300.

When web pages are accessed via the browser 300, logic defining various characteristics of the web page may be set forth in scripts that are retrieved from the document object model (DOM) of the web page when the web page is loaded and then executed and/or applied by the client device 20 via the browser 300. For example, if the web page includes a fillable form that includes drop-down menus as inputs for fields, the logic may define what combinations of inputs are allowed for different fields. If the form is to specify options for a mobile phone for order, a more premium trim level of a mobile phone may be available in different colors and/or different memory capacities than a more basic trim level of the same phone. Accordingly, logic may be run by the client device 20 to determine available options for other parameters given the parameters that have been specified. However, attempts to fill out the form using resources that are external to the browser 300, such as a virtual agent or chat bot, may result in combinations of parameters that violate the logic, because the form is not being accessed via a browser and thus the logic is unavailable because the DOM cannot be accessed.

To address this, logic may be stored in scripts in a scripts database 302 (which may the same or different from the virtual database servers 104A, 104B shown in FIG. 2) on the server 26 side, either within or accessible by the vertical server 26 and/or the client instance 102. Specifically, as is described in more detail below, when a request to access and/or fill out a form is received as an input 304, the client instance 102 identifies the script(s) that defines the logic for the form and retrieves the script(s) from the scripts database 302. The client instance 102 generates a javascript proxy object and uses the javascript proxy object to execute the retrieved script(s). Execution of the script results in data being generated, which is transmitted to the client device 20 as an output 306. The client device 20 may provide additional inputs 304 (e.g., specifying values for fields within the form), which may cause the client instance 102 to run or re-run the retrieved scripts, resulting in additional data, which may be transmitted back to the client device 20 as outputs 306 (e.g., defining available input values for fields of the form that have not yet been defined). Further, additional inputs 304 may be received changing values of previously specified fields within the form. The client instance 102 may run or re-run the retrieved scripts to identify one or more fields that had been previously specified but are no longer compatible with the changed value and provide an output 306 to the client device 20 requesting new values for the identified fields based on the available options. As additional inputs are received, scripts may be re-run.

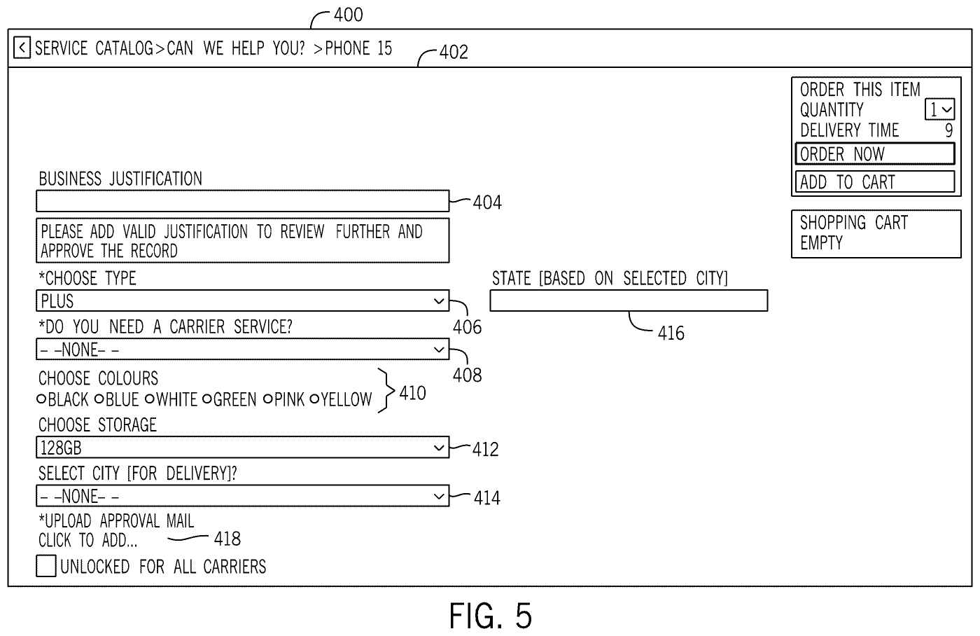

FIG. 5 is a screenshot of a web page 400, accessible via a browser, that includes a form 402 for ordering a mobile phone. As shown, the form 402 includes various fields for specifying various characteristics of the phone and/or the order.

A business justification field 404 allows for a user to input words setting forth a business justification for the phone. The logic of the form may specify that a business justification may or may not be required, or that a business justification may be required for some (e.g., more premium) phone models, but not other (e.g., more basic) models. The lack of an asterisk next to the business justification field 404 indicates that a business justification is not required to order the phone, however, an asterisk may appear, as a result of logic being run, if a more expensive model of phone is selected. In some embodiments, a business justification may be submitted for review and approved before an order is fulfilled.

A type field 406 allows a user to provide inputs specifying the type (e.g., model) of phone. For example, the input may specify “Pro” for a more premium phone with more processing power, more premium features, and/or more expensive materials. Further, the input may specify “Plus” for a large phone with a larger screen, or “Pro Max”for a premium phone with a larger screen.

The carrier service field 408 receives inputs selected from a dropdown menu of available cellular carriers. In some embodiments, the input may specify “none”, or select the checkbox at the bottom of the form, if the requestor does not wish for the phone to be tethered to a particular cellular carrier.

The color field 410 receives inputs selecting a desired color of the phone. For example, the input may specify “black”, “blue”, “white”, “green”, “pink”, or “yellow”.

The storage field 412 receives inputs specifying the storage capacity of the phone. For example, the storage capacity may be 128 gigabytes (GB), 256 GB, 512 GB, 1 terabytes (TB), 2 TB, and so forth.

The city field 414 receives inputs specifying the city to which the requester would like the phone delivered. The state field 416 auto-populates the state of the city input to the city field 414.

The upload approval mail field 418, when selected, allows a requester to upload an email approving purchase of the phone. The form 402 may allow the user to drag and drop the email into the approval mail field 418, or select an option to browse his or her computer to locate the approval email. For some phone model/types approval may not be required.

As previously described, underlying logic defined by scripts may dictate various combinations of allowed parameters. For example, certain storage sizes, colors, etc. may only be available for certain phone types (e.g., models). For example, the “Pro” version of the phone may be available with “1 TB” of memory, while the largest memory available in the “Standard” version may be “512 GB”. Further, some colors may only be available in “Pro” type phones or “Plus” type phones. Accordingly, logic defined in a script may define what combinations of parameter values are available. The value selected in the phone type field (e.g., “Standard”, “Plus”, “Pro”, “Pro Max”, etc.) may determine what values are available for other parameters of the phone, such as color, memory, etc.

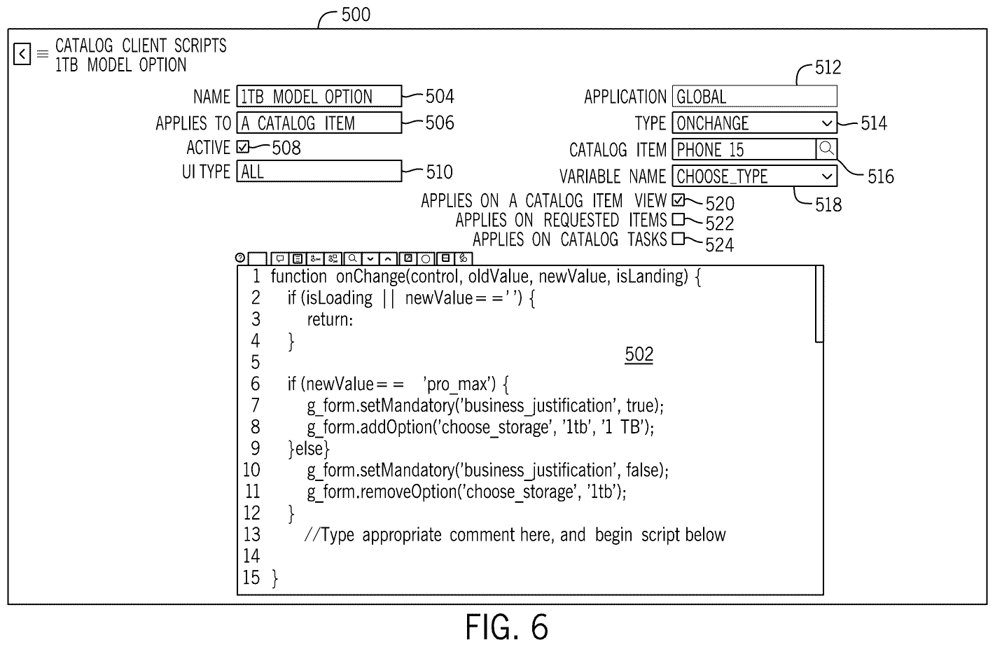

FIG. 6 is a screenshot of a script editing window 500 for editing a script 502 associated with the form 402 shown in FIG. 5. The script name field 504 indicates the name of the script 502. The applies to field 506 indicates items to which the script 502 applies. In the embodiment shown in FIG. 6, the script 502 applies to a catalog item, however, in other embodiments, the script 502 may apply to other items. The active checkbox 508 indicates whether or not the script 502 is active. The check mark shown in FIG. 6 indicates the script 502 is active and run for the respective item, whereas no check mark indicates that the script 502 is inactive and thus is not run for the respective item. The user interface (UI) type field 510 indicates the user interface type to which the script 502 applies. Though the UI type field 510 of FIG. 6 indicates that the script 502 applies to all UI types, in some embodiments, a script 502 may only apply to specific UI types, such as web browsers, native applications, mobile, chat, etc. The application type field 512 indicates whether the application is a global application, as is shown in FIG. 6, or a scoped application (e.g., the application is only accessible to certain users and/or the application has access to certain data). The script type field 514 indicates that the script 502 is of a specific type. The script 502 shown in FIG. 6 is an “onChange” type script, meaning that the script is run when values for certain fields of the underlying form are changed. The catalog item field 516 indicates the catalog item to which the script applies, in this case “Phone 15”. The variable name field 518 indicates the variable (e.g., the field of the underlying form) to which the script 502 applies. For example, in the embodiment illustrated in FIG. 6, the script 502 runs when an input is received changing the value for the “type” field in the form for a Phone 15. The applies on a catalog item view checkbox 520 indicates whether or not the script 502 applies in a catalog item view. The applies on requested items checkbox 522 indicates whether the script 502 applies on requested catalog items. The applies on catalog tasks checkbox 524 indicates whether or not the script 502 applies to catalog tasks.

As shown in FIG. 6, the script 502 applies when an input is received changing the type field in an order form for a Phone 15. The code of the script 502 shown in FIG. 6 specifies that if the type field is changed to “Pro Max”, and a business justification is provided, the “1 TB” memory option is made available in the storage field. However, if a business justification has not been provided, the “1 TB” memory option is removed from the available memory options in the storage field. Accordingly, the script 502 makes the “1 TB” memory option unavailable for a Phone 15 if the “Pro Max” option has been selected and a business justification has not been provided.

Though FIGS. 5 and 6 illustrate a specific embodiment using scripts to configure combinations of parameters for fields of a form for a particular catalog item (e.g., a Phone 15), it should be understood that this is merely an example used for illustrative purposes and that it should be understood that scripts may be used to define different combinations of parameters for field values for a wide variety of catalog items, as well as other forms. Accordingly, embodiments are envisaged in which the disclosed techniques can be applied to many different combinations of parameters for field values for a wide range of forms. As such, the embodiments shown in FIGS. 5 and 6 are not intended to limit the scope of the claims.

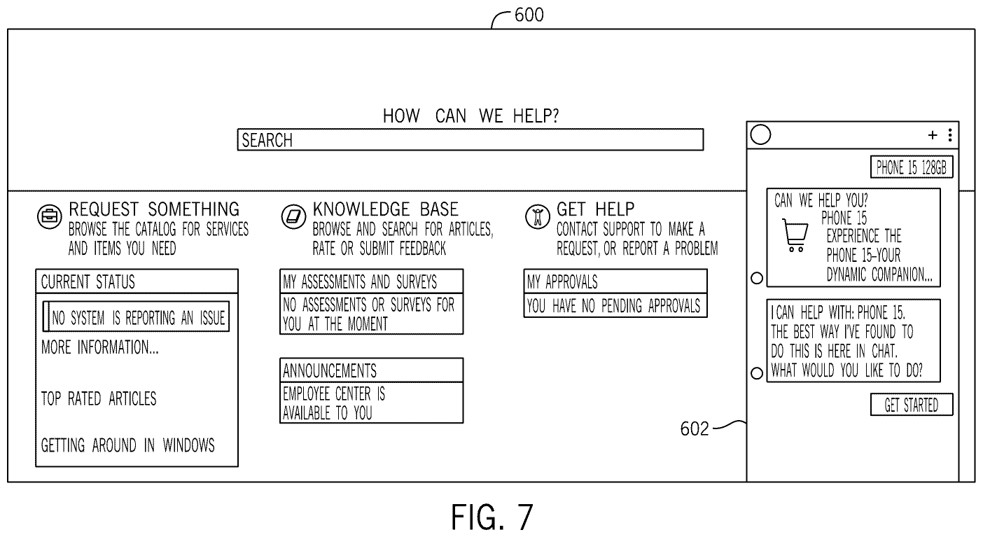

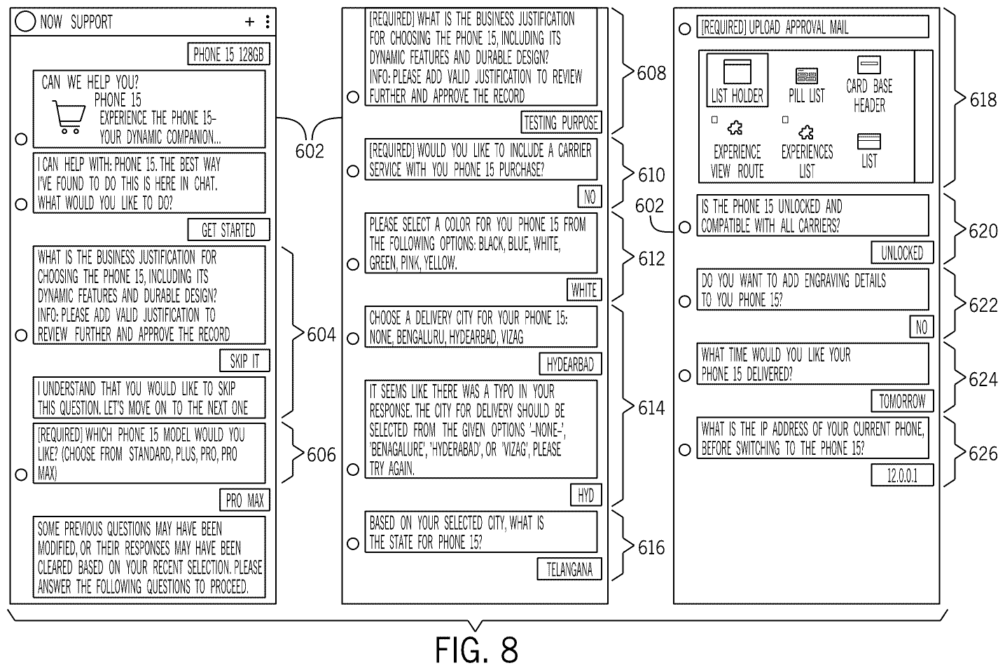

FIGS. 7 and 8 illustrate a chat interface for filling out a form of FIG. 5 external to a browser. Specifically, FIGS. 7 and 8 illustrate how the form for ordering a Phone 15 of FIG. 5 can be filled out and submitted via a chat interface with a virtual agent. FIG. 7 is a screenshot of a home screen 600, accessible via a client device (e.g., a computer, tablet, mobile device, etc.), from which a chat conversation can be launched and conducted in a chat window 602 to order a catalog item, in this case a Phone 15, via a virtual agent. As shown, the user types “phone 15 128gb” indicating a desire to order a Phone 15 with 128 GB of memory. As shown, the virtual agent identifies the relevant catalog item and asks if the user would like to complete the order form via chat. By typing “Get started”, the user communicates a desire to fill out the order form via chat.

FIG. 8 shows the entire chat conversation that was initiated in FIG. 7. At 604 the virtual agent asks the user about a business justification for the item, but the user instructs the virtual agent to skip the business justification. At 606, the virtual agent asks the user which model on Phone 15 the user would like and lists the options (e.g., “Standard”, “Plus”, “Pro”, and “Pro Max”). The user selects “Pro Max”.

At 608, the virtual agent returns to asking about business justification, indicating that a script was run on the back end and that the user's selection of the “Pro Max” model requires that the user provide a business justification. The user indicates that the business justification is testing purposes.

At 610, the virtual agent asks whether the user would like to include carrier service with the Phone 15. The user declines. At 612, the virtual agent asks the user to select a color and gives a list of options. The user selects “white”. At 614, the virtual agent asks the user to identify a city to which the phone will be delivered. As shown, in some embodiments, the virtual agent may make suggestions based on previously known information about the user (e.g., their profile, office location, residency information, where previous orders have been delivered, and so forth). In responding the user makes a typo, the virtual agent recognizes the typo and asks for clarification. At 616, the virtual agent asks about the state to which the item is to be delivered.

At 618, the virtual agent asks the user to upload an email providing approval for the business justification to order the item. The user may browse for the file, drag and drop the file, or locate the file some other way. At 620, the virtual agent asks whether the user wants an unlocked phone so the phone is compatible with all carriers and the user indicates that they do want an unlocked phone. At 622, the virtual agent asks about engraving and the user indicates that he or she is not interested in engraving. At 624, the virtual agent asks the user when the user would like the phone delivered and the user indicates the next day. At 626 , the virtual agent asks for the IP address of the user's current phone so the virtual agent can help the user move data to the new phone when it arrives. The order is then complete.

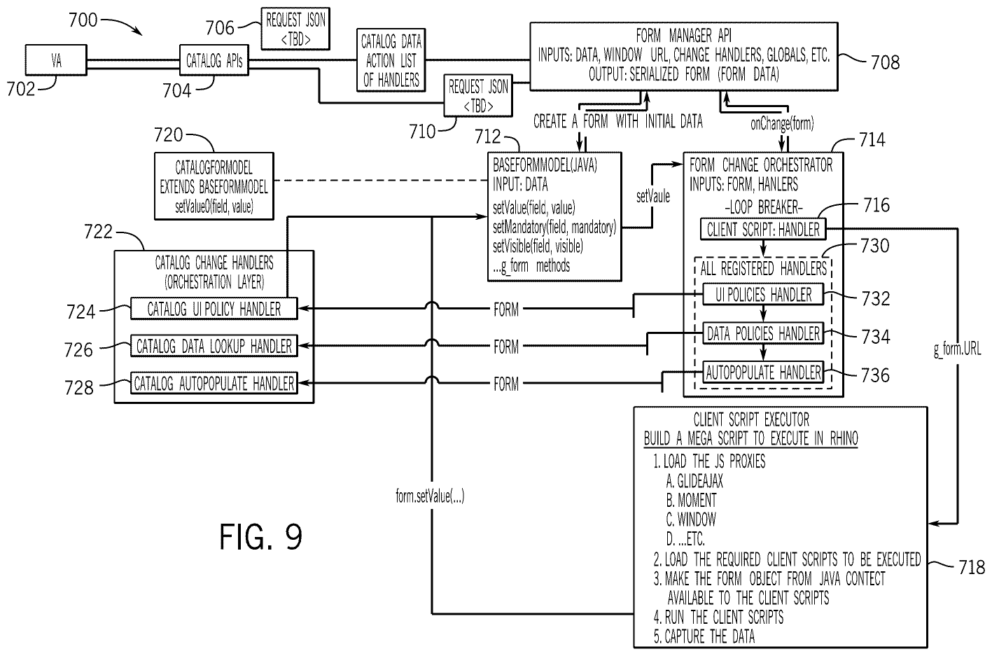

FIG. 9 is a flow chart illustrating the operations of a backend system (e.g., a client instance, a virtual server, a server, etc.) as a form is filled out using resources external to a web browser (e.g., via the chat session with the virtual agent shown in FIGS. 7 and 8). As shown, a virtual agent 702 accesses one or more catalog application programming interfaces (APIs) 704 that may be utilized by the virtual agent 702 to access and fill out catalog forms. The catalog APIs 704 transmit one or more JavaScript Object Notation (JSON) requests 706 to a form manager API 708. The JSON requests may specify, for example, catalog data, actions to be taken, a list of handlers to be used, etc. The form manager API 708 uses various software modules, such as handlers, executors, models, etc. to generate one or more JSON responses 710 that are transmitted back to the virtual agent 702 via the catalog APIs 704. As used herein, a handler is a javascript object configured to receive messages from an object and export the messages by writing the messages to a file, exporting messages to another object, a console, a service, etc. As used herein, an executor is a javascript object that executes submitted tasks. The form manager API 708 receives as inputs catalog data, a uniform resource locator (URL) for a browser window, identification of one or more change handlers, identification of one or more global variables, and so forth. The form manager API 708 generates a first form object (e.g., a g_form, which is a javascript class) based on the received catalog data and passes the first form object to a BaseFormModel java model 712.

The form manager API 708 also generates a second form object (e.g., an OnChange g_form) based on the received inputs and passes the second form object to a form change orchestrator 714. The form change orchestrator 714 receives set values from the BaseFormModel java model 712 based on the initial catalog data provided to the form manager API 708 as inputs. As used herein, an orchestrator is a software tool that facilitates management, coordination, and configuration of systems and/or services. The form change orchestrator 714 uses a client script handler 716 to pass a form object (e.g., the second form object) and the window URL to a client script executor 718, which builds a script for execution. Specifically, the client script executor 718 loads one or more javascript proxies, loads identified client scripts to be executed, and generates a form object from a java context available to the client scripts. The client script executor 718 then runs the client scripts and captures data generated from the scripts being run. The captured data may include, for example, results of script execution, errors encountered during execution, and any notifications or messages that arose during execution. The client script executor 718 returns the data to the BaseFormModel java model 712.

The BaseFormModel java model 712 may also receive data from a catalog form java model 720, which may be an extension of the BaseFormModel java model 712, as well as catalog change handlers 722, which may run in an orchestration layer. The catalog change handlers 722 may include, for example, a catalog UI policy handler 724 configured to manage and apply catalog user interface policies, a catalog data lookup handler 726 configured to retrieve catalog data from a database (e.g., a catalog data database), a catalog auto-populate handler 728 configured to auto-populate forms in compliance with UI policies and based on catalog data retrieved by the catalog data lookup handler 726. As changes are made to values in the form and client scripts are run, the BaseFormModel java model 712 generates updated field values and passes the updated field values to the form change orchestrator 714.

As shown, the form change orchestrator 714 may include one or more additional handlers 730 configured to perform specific actions as inputs are received setting and or changing values for field of the underlying form. For example, a UI policies handler 732 may be configured to interface with the catalog UI policy handler 724 to manage and apply user interface policies. A data policies handler 734 may be configured to interface with the catalog data lookup handler 726 to manage and apply policies related to data (e.g., encryption, anonymization, etc.). An auto-populate handler 736 may be configured to interface with the catalog auto-populate handler 728 to auto-populate retrieved data in compliance with the data policies.

As shown, the form manager API 708 receives data from the various software modules, such as handlers, executors, models, etc. and generates the JSON responses 710, which are transmitted back to the virtual agent 702 via the catalog APIs 704, and subsequently relayed back to the client device. As the virtual agent proceeds through a form, the received data may be used to determine whether a field is required, the available options for that field based on values previously provided for other fields, and so forth.

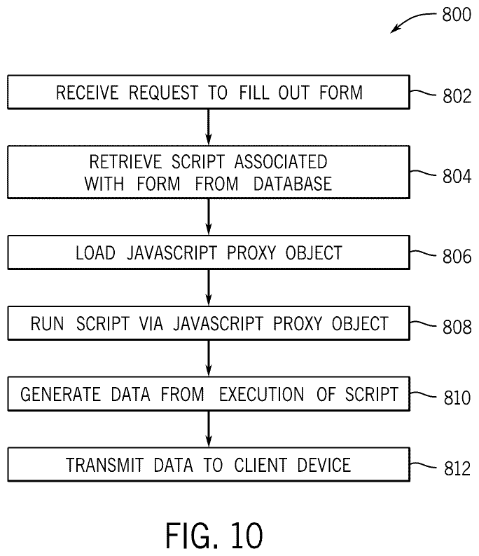

With the foregoing in mind, FIG. 10 is a flow chart of a process 800 for running client-side logic on a server. At 802, the process 800 receives a request to fill out a form. The request may be received at a server from a client device (e.g., a computer, a tablet, a mobile device, etc.). In some embodiments, the request may be to fill out the form using resources that are external to a browser. For example, the request may be to fill out a form using a chat interface, a native application, or some other resource that may not utilize a web browser.

At 804, the process 800 retrieves one or more client scripts associated with the identified form from a scripts database. The scripts may be run to determine, for example, what combinations of parameter values are permissible and/or available. For example, a script may be used to determine, based on values already input for fields of a form, what values are available for a particular field of the form.

At 806, the process 800 loads a javascript proxy object. As used herein, a javascript proxy object is a javascript object that can be used in place of, or act as a proxy for, a target javascript object, but can be used to redefine fundamental operations (e.g., get, set, and define properties) of the target object. A javascript proxy object is created based on two parameters—a target object to be proxied, and one or more handlers (e.g., objects that define which operations are redefined and how). The javascript proxy object enables the client-side script to be run on the server side, whereas previously, client-side scripts were retrieved from the DOM of a webpage and executed within the browser of a client device. Accordingly, loading a javascript proxy object on the server side enables client-side scripts to run on the server side, which allows client-side logic to be applied to forms that are filled in external to a browser. At 808, the retrieved client-side scripts are run on the server side via the javascript proxy object, resulting in the generation of data (block 810). At 812, the generated data is transmitted to the client device. As previously described, the transmitted data may specify what values are available for one or more fields of a form based upon values for fields that have already been specified.

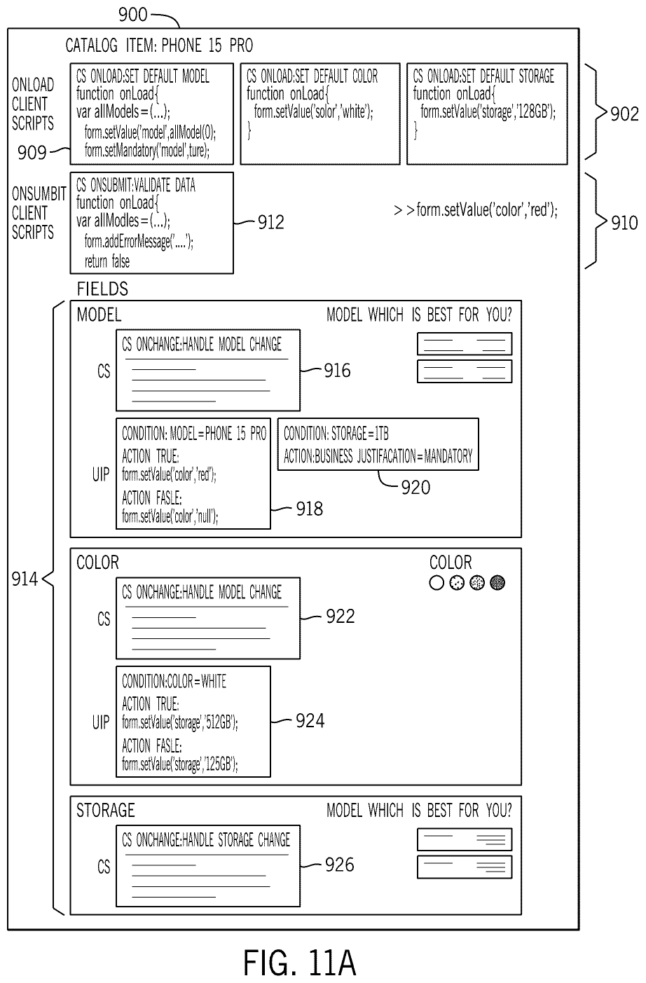

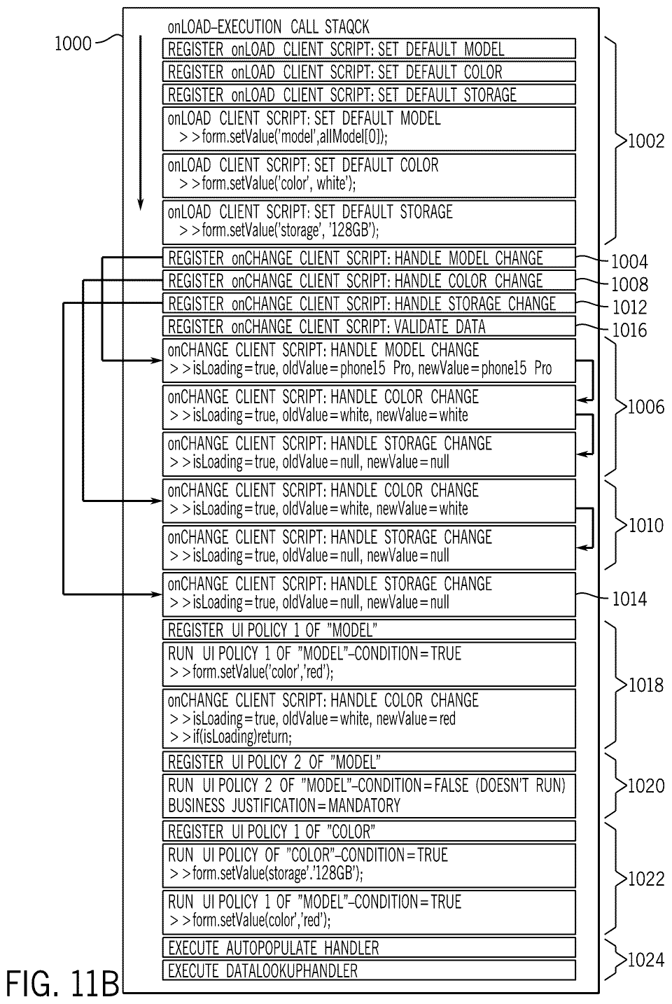

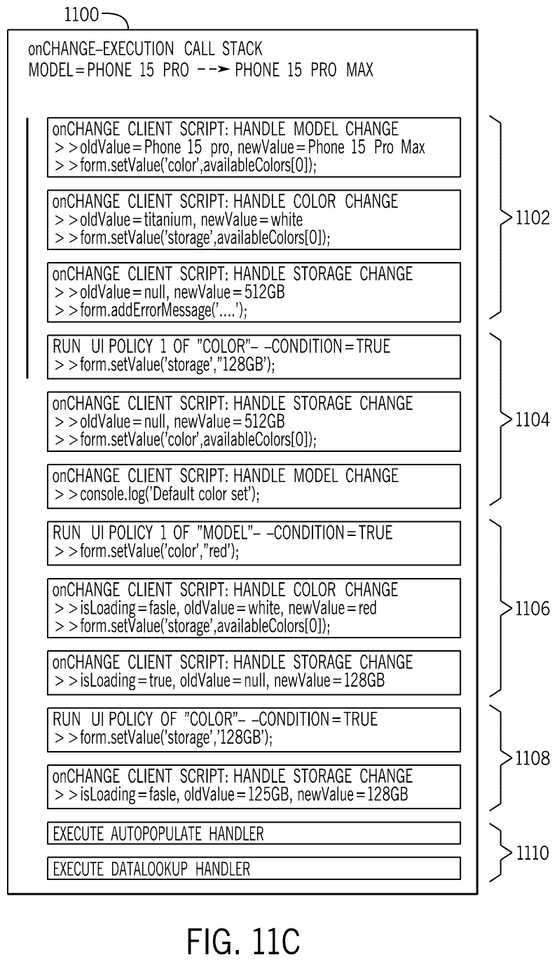

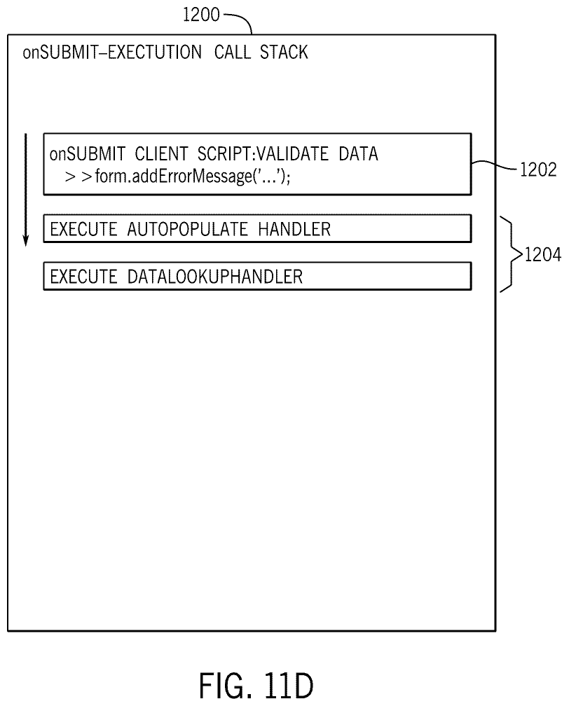

FIG. 11A is a schematic 900 of client scripts for a catalog item for a Phone 15. As shown, a first set of scripts 902 run upon the page for the catalog item being loaded. This first set of scripts may include, for example, a set default model script 904, a set default color script 906, and a set default storage script 908. As the script names indicate, the first set of scripts set default values for fields within the form of the catalog item when it is loaded. For example, the set default model script 904 sets the default model value to “model” (e.g., the default value for model does not select one of the available model options), and also indicates that model is a mandatory or required to be specified for successful submission. The set default color script 906 sets the default color value to “white” and the set default storage script 908 sets the default storage value to “128 GB”.

A second set of scripts 910, in the embodiment shown in FIG. 11A, is run upon submission of the form and/or submission of values for fields of the form. Specifically, a validate data script 912 is run to validate values for fields of the form submitted. If any error messages arise, the user may be notified (e.g., via a notification or message transmitted to the client device) and asked to modify one or more values.

A third set of scripts 914 are run when changes are made to specific fields. For example, a handle model change script 916 may be run when a change is made to the value in the model field of the form. For example, as shown in 918, when the model is changed to “Phone 15 Pro”, the color is set to “red”, otherwise, the color is set to “null”. Similarly, as shown in 920, when the storage is changed to “1 TB”, the business justification becomes mandatory. A handle color change script 922 is run when the value for the field of color is changed. As shown in 924, when the color is changed to “white”, the storage value is set to “512 GB”, and if the color is changed to a color other than “white”, the storage value is set to “128 GB”. A handle storage change script 926 is run when the value for the storage field is changed. Accordingly, the handle storage change script 926 may be configured to validate other values when the value for the storage is changed and transmit an error message if the values do not pass validation.

FIG. 11B is a schematic of an on-load execution call stack 1000 that represents actions taken when the Phone 15 catalog item form is loaded. As shown, at 1002, the set default model script 904, set default color script 906, and the set default storage script 908 from FIG. 11A are run, resulting in a default model value of “all models”a default color of “white”, and a default storage of “128 GB”.

At 1004, in response to a value being changed in the model field, the handle model change script 916 from FIG. 11A is run and the stack 1000 proceeds to 1006 in which model is changed to “Phone 15 Pro”, the color remains “white”, and the storage is changed to “null”. At 1008, in response to a value being changed in the color field, the handle color change script 922 from FIG. 11A is run and the stack 1000 proceeds to 1010 in which the color is “white” and the storage is “null”. At 1012, in response to a value being changed in the storage field, the stack 1000 proceeds to 1014 and updates the value to “null”.

At 1016, upon submission of a new value for a field of the form or submission of the completed form, the validate data script 912 is run to validate received data and determine whether or not any errors arise. If errors do arise, the user may be prompted to correct the errors (e.g., via a notification or message transmitted to the client device).

At 1018, the stack 1000 registers a UI policy for the model field of the form. If the condition for the UI policy is true, the value for the color field may be changed to “red”. The handle color change script 922 may then be run to change the value of the color field from “white” to “red”. At 1020, the stack 1000 registers an additional UI policy for the model field of the form. If the condition for the UI policy is false, the business justification field may be made mandatory. At 1022, the stack 1000 registers a UI policy for the color field of the form. If the condition for the UI policy is false, the storage field may be set to “128 GB” by running the handle storage change script 926 of FIG. 11A. At 1024, the auto-populate handler 736 and the data lookup handler 726 of FIG. 9 may be executed.

FIG. 11C is a schematic of an on-change execution call stack 1100 that represents actions taken when the value of the model field is changed from “Phone 15 Pro” to “Phone 15 Pro Max”. At 1102, the handle model change script 916 from FIG. 11A is run to change the value of the model field from “Phone 15 Pro” to “Phone 15 Pro Max”. The handle color change script 922 from FIG. 11A is run to change the color value from “titanium” to “white”. The handle storage change script 926 of FIG. 11A is run to change the storage value from “null” to “512 GB”.

At 1104 the UI policy of color is run based on the storage field having a value of “128 GB”. The handle storage change script 926 of FIG. 11A is run to change the value in the storage field from “null” to “512 GB”. The handle model change script 916 from FIG. 11A is run to set the default value in the color field.

At 1106, the UI policy of model is run based on the color field having a value of “red”. The handle color change script 922 from FIG. 11A is run to change the color value from “white” to “red”. The handle storage change script 926 of FIG. 11A is run to change the storage value from “null”to “128 GB”.

At 1108, the UI policy of color is run based on the storage field having a value “128 GB”. The handle storage change script 926 of FIG. 11A is run to keep the storage value at “128 GB”. At 1110, the auto-populate handler 736 and the data lookup handler 726 of FIG. 9 may be executed.

FIG. 11D is a schematic of an on-submit execution call stack 1200 that represents actions taken when values for fields in the form are submitted. At 1202, the validate data script 912 of FIG. 11A is run to validate received data and determine whether or not any errors arise. If errors do arise, the user may be prompted to correct the errors. At 1204, the auto-populate handler 736 and the data lookup handler 726 of FIG. 9 may be executed.

Though FIGS. 11A-11D illustrate specific embodiments of using scripts to configure combinations of parameters for fields of a form for a particular catalog item (e.g., a Phone 15), it should be understood that these are merely examples used for illustrative purposes and that it should be understood that scripts may be used to define different combinations of parameters for field values for a wide variety of catalog items, and indeed other forms. Accordingly, embodiments are envisaged in which the disclosed techniques can be applied to many different combinations of parameters for field values for a wide range of forms. As such, the embodiments shown in FIGS. 11A-11D are not intended to limit the scope of the claims.

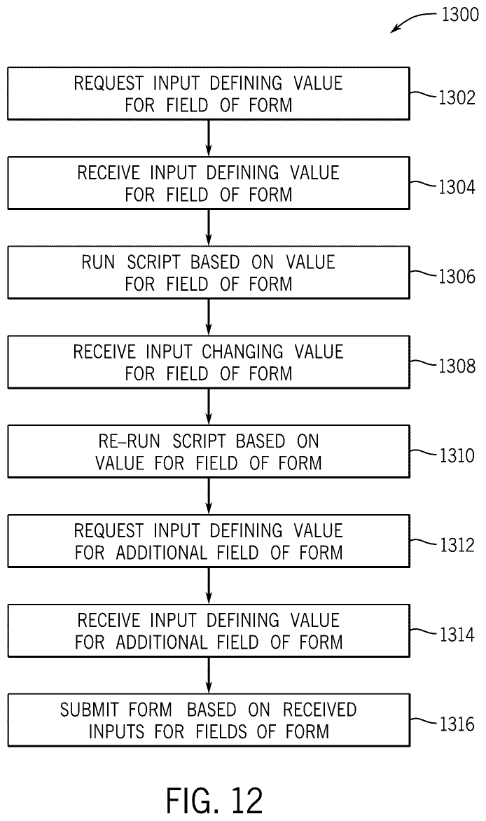

FIG. 12 is a flow chart of a process 1300 for managing form completion when a change is made to a value for a field of the form. At 1302, the process 1300 requests an input defining a value for a field of a form. For example, the process 1300 may transmit a request to a client device or, as shown and described with regard to FIGS. 7 and 8, a virtual agent may ask for an input defining a value for a field of the form in a chat session. The field may specify a characteristic of a catalog item, a characteristic of an order, a characteristic of a service request, or any other field of a form. At 1304, the input defining a value for the field of the form is received. The input may be received as natural language, the first few characters of an option presented, spoken language, a gesture, selection of a button or a drop down menu, a keystroke, selection via a mouse or stylus, or any other type of input.

At 1306, a script associated with the field, the input, and/or the form is run based on the value for the field of the form received at 1304. In some embodiments the one or more scripts may be identified and retrieved from a scripts database stored on a server before the script is run. The output of the script may dictate, for example, allowed values for one or more other fields of the form based on the input received at 1304, and in some cases, previously specified values for one or more other fields of the form.

At 1308, the process 1300 receives an additional input changing the value for the field of the form received at 1304. At 1310, the script is re-run based on the updated value for the field of the form. In the illustrated embodiment, the one or more scripts run at 1310 are the same as the one or more scripts run at 1306. However, in some embodiments, the change to the value may cause one or more additional scripts, or one or more different scripts to be retrieved from a scripts database and run. As with the script run at 1306, the output of the script may dictate, for example, allowed values for one or more other fields of the form based on the input received at 1308, and in some cases, previously specified values for one or more other fields of the form.

At 1312, the process 1300 requests an input defining a value for an additional field of a form. As with the request at 1302, the request may be transmitted to a client device and/or presented at a client device via a virtual agent. At 1314, the input defining a value for the additional field of the form is received. As with the input received at 1304, the input may be received as natural language, the first few characters of an option presented, spoken language, a gesture, selection of a button or a drop down menu, a keystroke, selection via a mouse or stylus, or any other type of input.

The process 1300 may continue until all of the fields of the form are defined, or at least until all of the required/mandatory field of the form have been defined. Up the form being completed, or the mandatory fields of the form being completed, at 1316, the form is submitted based on the received inputs defining values for the fields of the form. In some embodiments, as previously described, validation of the data for the values of the fields of the form may be performed before submission or upon submission to confirm validity of the data.

The presently disclosed techniques are directed to executing scripts that are typically executed client side (e.g., via a browser) on the server side. For example, parameters of items within a catalog may be defined by a form. Some catalog items may only be available in specific combinations of parameters. For example, a more premium trim level of a mobile phone may be available in different colors and/or different memory capacities than a more basic trim level of the phone. Logic dictating which combinations of parameters are available is defined by scripts, which are typically stored in a document object model (DOM) of the form's webpage. The browser typically extracts the scripts from the DOM and runs the scripts on the client device to apply the logic. However, attempts to fill in forms using resources that are external to a browser (e.g., via a virtual agent) may result in forms being submitted with combinations of parameters that do not exist because the resources that are external to the browser do not have access to the DOM, and thus do not have access to the scripts that define the logic. In the presently disclosed embodiments, the scripts are retrieved from a scripts database and executed by a javascript proxy object on the server side. Execution of the scripts results in data used to determine which combinations of parameters are possible, enabling options to be provided to a client device in a conversational format. Further, if inputs are received that make a change to a previously defined parameter, the scripts may be re-run to determine the available combinations of parameters based on the change.

Technical effects of the disclosed techniques include enabling logic (e.g., client-side scripts) that is typically run on the client side to be run on the server side. Accordingly, resources that are external to a browser, such virtual agents, can be used to fill in forms and inputs/submissions can be checked by running logic on the server side. As a result, form submissions with inputs that violate logic, which can greatly reduce process efficiency and be resource intensive to correct, are greatly reduced.

The specific embodiments described above have been shown by way of example, and it should be understood that these embodiments may be susceptible to various modifications and alternative forms. It should be further understood that the claims are not intended to be limited to the particular forms disclosed, but rather to cover all modifications, equivalents, and alternatives falling within the spirit and scope of this disclosure.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S. C. 112(f). However, for any claims containing elements designated in any other manner, it is intended that such elements are not to be interpreted under 35 U.S. C. 112(f).

1. A method comprising:
receiving, from a client device, a request to fill out a form;
retrieving a script associated with the form;
generating, via a javascript proxy object, data based on the script; and
transmitting the data to the client device.

2. The method of claim 1, comprising:
providing, to the client device, a request for an input defining a value for a field of the form; and
receiving, from the client device, the input.

3. The method of claim 2, comprising:
receiving a second input changing the value of the field of the form;
regenerating, via the javascript proxy object, the data based on the script, wherein the data defines available values for a second field of the form based on the change to the value of the form;
providing, to the client device, a request for a third input defining a second value for the second field of the form; and
receiving, from the client device, the third input.

4. The method of claim 3, wherein the form comprises an order for a catalog item.

5. The method of claim 4, wherein the script defines possible combinations of characteristics of the catalog item.

6. The method of claim 2, comprising auto-populating, via an auto-populate handler of the javascript proxy object, the field of the form.

7. The method of claim 6, comprising determining, via a UI policy handler of the javascript proxy object, one or more characteristics of a user interface transmitted to the client device for display.

8. The method of claim 6, comprising retrieving, via a catalog data lookup handler of the javascript proxy object, catalog data for one or more catalog items from a catalog data database.

9. The method of claim 1, wherein the script is retrieved via a script handler of the javascript proxy object.

10. A system, comprising:
processing circuitry; and
a memory, accessible by the processing circuitry, and storing instructions that, when executed by the processing circuitry, cause the processing circuitry to execute a client instance, wherein the client instance is configured to perform operations comprising:
receiving, from a client device, a request to fill out a form;
retrieving a script associated with the form;
generating, via a javascript proxy object, data based on the script; and
transmitting the data to the client device.

11. The system of claim 10, wherein the operations comprise:
providing, to the client device, a request for an input defining a value for a field of the form; and
receiving, from the client device, the input.

12. The system of claim 11, wherein the operations comprise:
receiving a second input changing the value of the field of the form;
regenerating, via the javascript proxy object, the data based on the script, wherein the data defines available values for a second field of the form based on the change to the value of the form;
providing, to the client device, a request for a third input defining a second value for the second field of the form; and
receiving, from the client device, the third input.

13. The system of claim 12, wherein the form comprises an order for a catalog item.

14. The system of claim 13, wherein the script defines possible combinations of characteristics of the catalog item.

15. The system of claim 11, wherein the operations comprise, auto-populating, via an auto-populate handler of the javascript proxy object, the field of the form.

16. The system of claim 15, wherein the operations comprise determining, via a UI policy handler of the javascript proxy object, one or more characteristics of a user interface transmitted to the client device for display.

17. The system of claim 15, wherein the operations comprise retrieving, via a catalog data lookup handler of the javascript proxy object, catalog data for one or more catalog items from a catalog data database.

18. A non-transitory, computer readable medium comprising instructions that, when executed by processing circuitry, cause the processing circuitry to perform operations comprising:
receiving, from a client device, a request to fill out a form;
retrieving a script associated with the form;
generating, via a javascript proxy object, data based on the script; and
transmitting the data to the client device.

19. The non-transitory, computer readable medium of claim 18, wherein the operations comprise:
providing, to the client device, a request for an input defining a value for a field of the form;
receiving, from the client device, the input;
receiving a second input changing the value of the field of the form;
regenerating, via the javascript proxy object, the data based on the script, wherein the data defines available values for a second field of the form based on the change to the value of the form;
providing, to the client device, a request for a third input defining a second value for the second field of the form; and
receiving, from the client device, the third input.

20. The non-transitory, computer readable medium of claim 18, wherein the operations comprise:
auto-populating, via an auto-populate handler of the javascript proxy object, a field of the form;
determining, via a UI policy handler of the javascript proxy object, one or more characteristics of a user interface transmitted to the client device for display; and
retrieving, via a catalog data lookup handler of the javascript proxy object, catalog data for one or more catalog items from a catalog data database.
